(19) United States
(12) Patent Application Publication
(10) Pub. No.: US 2010/0191557 A1
(43) Pub. Date: Jul. 29, 2010

(54) Usage-Limited Product Warranties

(76) Inventors: Julie Ward Drew, Redwood City, CA (US); Jose Luis Beltran Guerrero, Palo Altos, CA (US); Ming Hu, Toronto (CA); Guillermo Gallego, Waldwick, NJ (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/359,823

(22) Filed: Jan. 26, 2009

(51) Int. Cl. G06F 17/30

(52) U.S. Cl. 705/7

(57) ABSTRACT

The present disclosure is directed to methods for pricing limited use product warranties to increase profit. Such a method can include selecting a plurality of potential warranty options, where each warranty option has an associated product usage limit and an associated warranty purchase cost; calculating a customer's expected support cost; determining a customer demand for each of the plurality of warranty options; calculating a provider's expected option profit for each of the plurality of warranty options; and calculating a provider's expected total profit for the plurality of warranty options.

### BACKGROUND

Manufacturers or retailers often sell extended warranties to customers as insurance against future product failures. In many cases, when a customer buys a product, the customer is given a choice of purchasing such an optional extended warranty. These optional extended warranties allow the customer to receive support and product repair services that are often above and beyond what is provided by any standard warranty associated with the product.

Certain customers, because of their usage patterns, usage environment, or other factors, may be susceptible to more product failures, and thus, may be more expensive to support than other customers. In this situation, a manufacturer will often price an extended warranty at a higher cost to offset the expense of these high-usage customers. These higher-cost warranties are thus less attractive to low-usage customers due to their lower expected usage of the product. When a manufacturer sells an extended warranty at a uniform price to all customers, regardless of their usage, low-usage customers are effectively subsidizing the support costs of high-usage customers. Such uniform pricing may be high enough to deter many low-usage customers from purchasing extended warranties, and may be less than the support cost for high-usage customers.

It may thus be beneficial for the manufacturer to utilize a mechanism enabling price discrimination based on a customer's expected support costs. If the customer's usage or environment can be observed and measured by the manufacturer, retailer, or third party selling the warranty, then the manufacturer could discriminate based on these factors. In particular, the manufacturer can offer a menu of warranties, each with its own usage limit and price. Such a mechanism may thus be beneficial to both consumers and warranty sellers to achieve equitable pricing and effective market segmentation across the range of consumers purchasing a particular product.

### BRIEF DESCRIPTION OF THE DRAWINGS

FIG. 1 depicts a method of pricing limited use product warranties associated with a product to increase profit in accordance with one embodiment of the present disclosure; and

FIG. 2 shows a simplified flow chart of a menu selection method according to another embodiment of the present disclosure.

### DETAILED DESCRIPTION

Before the present invention is disclosed and described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

In describing and claiming the present disclosure, the following terminology will be used in accordance with the definitions set forth below.

It is noted that, as used herein, the singular forms of “a,” “an,” and “the” include plural referents unless the context clearly dictates otherwise. Thus, for example, reference to “a warranty” includes one or more of such warranties, and reference to “the product claim” includes reference to one or more of such claims.

As used herein, the term “product usage limit” refers to the amount of usage that a product undergoes or is intended to undergo during a warranty period. In one aspect, the product usage limit could include product usage per unit time, i.e. product usage rate. In the case of a printer, a product usage rate could include, for example, the number of pages printed per month. In another aspect, the product usage limit could include a cumulative product usage limit. In the case of a printer, for example, warranty coverage could be terminated following the printing of a set number of total pages over the lifetime of the printer.

As is used herein, the term “product warranty” is used to describe an optional warranty that is purchased and associated with a product in order to cover claims made by the warranty purchaser for service, repairs, and/or replacement of the product during a warranty period.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “up to 1 year,” should be interpreted to include not only the explicitly recited values of 0 to 1 year, but also include individual values and sub-ranges within the indicated range. Thus, included in this numerical range are sub-ranges, such as from 1-3 months, from 2-4 months, and from 0-5 months, etc. This same principle applies to ranges reciting only one numerical value. Furthermore, such an interpretation should apply regardless of the breadth of the range or the characteristics being described.

The present disclosure is directed to product warranties and methods for increasing the profitability of product warranties. As described above, when a manufacturer sells an extended warranty priced at a uniform cost to all customers, regardless of usage, low-usage customers effectively subsidize the support costs of high-usage customers. In such cases, many low-usage customers forgo the purchase of extended warranties because the cost of the warranty outweighs the perceived benefit given the customer's expected use of the product. Similarly, customers having various usage expectations may have varying expectations as to the cost of an extended warranty for the product. As such, by providing customers with a selection of warranty options having a variety of product usage limits and a variety of associated prices, customers can choose a warranty that more closely suits their needs. For example, a low-usage customer can purchase a warranty at a lower cost that covers repairs or replacements of the product up to a specified cumulative usage limit. Such a system will be more profitable to a manufacturer or a distributor due to capturing a greater share of the low-usage market, while at the same time being more equitable to the customer who is now paying for a warranty that only covers their expected usage limit.

One difficult issue that arises is how to design and price a menu of extended warranties, where each warranty in the menu has a different usage limit and purchase price. The techniques disclosed herein present a solution to this problem by determining how many different options to offer in a menu, and for each option, the best price and usage limit. These techniques thus design and price menus to achieve a greater expected profit or larger market share for the manufacturer.

There are many factors that a manufacturer may consider to effectively design and price a warranty menu. For example, how does product usage rate affect the manufacturer's support costs? Specifically, what is the expected cost to support a customer with usage u during the warranty period? Also, what is the usage rate distribution over the population of customers? What are competitors offering? How much does a customer choose among the various warranty options on the market? All of these factors should be weighed carefully in the manufacturer's decision. The present methods assist a manufacturer to make such decisions in an analytical and automated way.

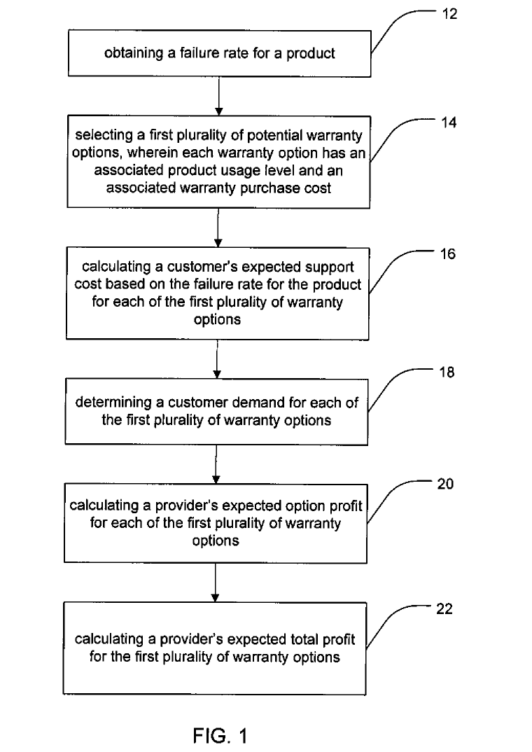

Accordingly, in one aspect of the present disclosure, as is shown in FIG. 1, a method of pricing limited use product warranties associated with a product to increase profit is provided. Such a method can include obtaining a failure rate for a product 12, and selecting a first plurality of potential warranty options 14, where each warranty option has an associated product usage limit and an associated warranty purchase cost. In one aspect, the failure rate can be obtained by accessing failure data associated with the product over a computer network from a database on a server. It should be noted that a failure rate is not necessarily a scalar value, but instead can vary over time for each customer. For example, in one aspect, the failure rate can be a function of the usage rate of the product. In another aspect, the failure rate can be a function of the age of the product. It is also to be understood that the failure rate can be a function of both the usage rate and the age of the product. It should be understood that failure rate can thus be a function of any factor that can be related to the failure of the product.

The method can additionally include utilizing a computer system to calculate a customer's expected support cost based on the failure rate or failure rates for the product for each of the first plurality of warranty options 16. In one aspect, the computer system can be operatively coupled to the computer network. Also, a customer demand for each of the first plurality of warranty options can be determined 18. The method also includes utilizing the computer system to calculate a provider's expected option profit for each of the first plurality of warranty options 20, and utilizing the computer system to calculate a provider's expected total profit for the first plurality of warranty options 22.

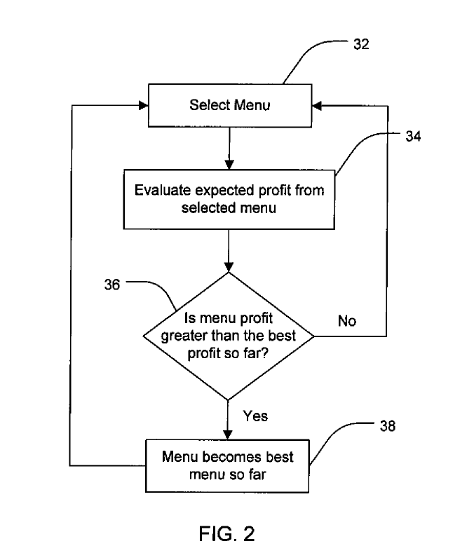

FIG. 2 describes a simplified method of such a warranty selection system. A menu or selection of potential warranties is selected 32, and the expected profit from this menu of warranties is evaluated 34. It is then determined whether or not the expected profit for that menu is greater than the best profit menu so far 36. If the selected menu does not have a higher expected profit than the best menu so far, then a new menu is selected and the process is repeated. If the expected profit is higher than the best menu so far, then the selected menu becomes the best menu so far 38, another menu is selected and the process is repeated until some termination condition is reached. It should be noted that in the first iteration of the model, the first menu selection will become the best menu so far and the process is repeated.

In another aspect, the method can further include selecting a second plurality of potential warranty options, where each warranty option has an associated product usage limit and an associated warranty purchase cost. The above recited process can then be repeated to calculate a provider's expected total profit for the second plurality of warranty options. Either the first plurality of warranty options or the second plurality of warranty options can then be retained. In one specific aspect, the set of warranty options that is retained can be the options having the highest provider's expected total profit. Thus,the highest provider's expected profit can be determined by comparing the provider's expected total profit for the first plurality of warranty options with the provider's expected total profit for the second plurality of warranty options, and then either the first or the second plurality of warranty options can be retained that has the highest provider's expected total profit.

The following assumptions may be useful in clarifying much of the following mathematical discussion. It should be noted that these definitions should not be seen as limiting, and are merely presented for the sake of clarification. For example, a heterogeneous group of customers with a random usage U over an extended warranty period [0,w] where w is the length in years of the warranty, is assumed. Additionally, without a loss of generality, time can be scaled such that w=1. It can also be assumed that customers know the realization of their usage u over the warranty period, and that the warranty provider knows the probability density function g(u) of the usage among different customers.

As a general description of the model, in one aspect, a warranty provider can offer a menu of m+1 numbers of warranties, represented by M={(pᵢ, lᵢ): i=0, . . . , m}, where pᵢ is the warranty purchase cost and lᵢ is the usage limit for a product. Thus, a customer that buys product i will pay pᵢ for a warranty that will cover up to cumulative usage limit lᵢ. If the usage is greater than the usage limit, the customer will be exposed to the cost of repairing those failures that occur after the usage limit. In some aspects, the situation (pₒ, lₒ)=(0, 0) can be included in the menu, thus representing customers who do not purchase a warranty, and thus pay out of pocket for each failure during the extended warranty period. There may also be one or more outside options available to customers, representing warranties or pay-as-you-go service offered by competing warranty providers.

In one aspect, the method can include obtaining failure and usage data in order to determine a failure rate for a product. In one aspect, such a failure rate can be obtained by accessing failure and usage data associated with the product over a computer network from a database on a server. As the database for failure and usage data of a product increases over time, the estimation of the failure rate should increase, thus allowing a more accurate prediction of total expected profit when establishing a plurality of warranty options.

The failure rate can assist in the evaluation of customer's potential costs and the provider's potential profits for a given product. Although a variety of methods can be utilized to estimate the failure rate, in one nonlimiting aspect it can be assumed that the number of failures N(t|u) up to time t is a non-homogenous Poisson process with rate λ(t|u) that is increasing in usage rate u. Accordingly, Equation (I)

$$E [ N ( t \vert u ) ] = {\int }_{0}^{t} λ ( s \vert u ) d s = Λ ( t \vert u ) \qquad ( I )$$

represents the expected number of failures over the interval [0, t] for a product with usage rate u.

Thus, the present methods generally include establishing a first selection of potential warranty options, and evaluating these warranty options to determine the total expected profit for using that selection of warranties with a product. A second selection of potential warranty options is then selected, and the total expected profit for this selection is calculated. The selection of warranty options having the highest total expected profit can then be utilized, either as the list of warranties to be used with the product, or to compare with additional selections of potential warranty selections in order to further improve the total expected profit.

The selection of warranties can include potential warranties having various associated product usage limits and warranty purchase costs. In one aspect, a random selection of potential warranties can be chosen for each of the total expected profit evaluations. In another aspect, a subsequent selection of potential warranties can include a previous selection of potential warranties having one or more substituted potential warranties. It should thus be recognized that any method of generating a selection of potential warranty options should be considered to be within the present scope.

A computer system that can be can be utilized to calculate a customer's expected support cost based on the failure rate for the product for each of the selection of warranty options. Although various methods for estimating the customer's expected support cost are contemplated, in one aspect, the customer's expected support cost includes the warranty purchase cost and an expected failure cost for failures that are not warranty-covered. In making the decision to purchase a warranty, a customer may evaluate the purchase cost of a given warranty against the customer's expected usage of the product, and how many failures may occur outside of the warranty for a given usage.

In one specific aspect, for example, a customer with usage rate u who selects product warranty (pᵢ, lᵢ) that is an element of M has expected cost according to Equation (II):

Jᵢ(u)=pᵢ+C_{R}vᵢ(u) (II)

where C_{R} is the expected cost of a single failure, and vᵢ(u) is the expected number of out-of-warranty failures for product warranty i at usage rate u. vᵢ(u) can be further described by Equation (III):

vᵢ(u)=(Λ(1|u)-Λ(lᵢu|u))⁺, i=0, 1 . . . , m (III)

Subsequently, if u≦lᵢ then vᵢ(u)=0, which then increases for u>Iᵢ. λ⁺(x|u) can be rewritten as λ(x|u) if x<1, and zero if x≧1. Let Jₐ(u) represent the expected cost of the outside alternative a to a customer with usage rate u. Let Equation (V)

Zᵢ(u)=Jᵢ(u)-cᵣΛ(1|u) (V)

denote the profit for the provider from a customer with usage u that selects warranty product (pᵢ, lᵢ) that is an element of M, where cᵣ is the expected repair cost to the provider. vᵢ(u) and therefore Jᵢ(u) and Zᵢ(u) are deterministic functions of u. However, vᵢ, Jᵢ, and Zᵢ are random variables that depend on the realization u of U.

There are many factors that influence consumers considering the purchase of an extended warranty. For example, a consumer may have brand and/or warranty provider preferences or prejudices, as well as overall risk preferences as it pertains to product warranties in general. Estimating the likelihood of a customer selecting a warranty option can greatly improve the estimate of total expected profit for a warranty provider. In one aspect, such a likelihood, or customer demand, can be subjectively estimated based on past experience with consumers. In another aspect, determining the customer demand for each of the plurality of warranty options can include utilizing the computer system to calculate a customer choice probability for each of the first plurality of warranty options.

In some aspects, a model can be used to reflect how customers choose among the available extended warranties on the market, including those offered by the manufacturer, and those offered by other service providers. The customer's decision is influenced by his own usage rate and possibly other factors such as risk preference or brand loyalty, as has been described. This choice can be affected by the attributes of the extended warranty options on the market, including price, brand, and usage limits.

One factor that influences a model of customer choice includes a customer's price sensitivity. For example, it can be assumed that a customer selects among the m+1 warranty products and the outside alternative according to a two step process. First, the customer with usage rate u selects among the m+2 alternatives, including the outside alternative. Let Iᵢ be a random variable that takes value 1 if the customer selects product i and zero otherwise, and let Iᵢ(u) be the random variable conditioned on usage U=u. Thus, under a Multinominal Logit Model, we have Equation (VI):

$$P ( {I}_{i} ( u ) = 1 ) = {Π}_{i} ( u ) = \frac{{e}^{- γ {J}_{i} ( u )}}{{e}^{- γ {J}_{a} ( u )} + {\sum }_{j = 0}^{m} {e}^{- γ {J}_{j} ( u )}} , \\ i = 0 , … , m , a \qquad ( VI )$$

where γ>0 is a choice sensitivity parameter. When γ is close to zero customers are insensitive to warranty costs and in the limit they would be equally likely to select any of the products. When γ is large, however, customers are very sensitive to warranty costs and are likely to select the product with the lowest cost. Intermediate values of γ arise as customers may have latent, zero mean, errors in valuating warranty costs.

In one aspect, the selection of potential warranty options can be evaluated using one choice sensitivity parameter. Thus, a total expected profit for a selection of warranties would be based on customers having similar cost sensitivity. In another aspect, the selection of potential warranty options can be evaluated using more than one sensitivity parameter. For example, the value of cost sensitivity parameter may depend on customer's usage rate, or other customer attributes. In such cases, a more accurate total expected profit can be calculated because multiple cost sensitivities may better reflect the distribution of consumers that potentially will purchase extended warranties. In some aspects, the selection of potential warranty options can be evaluated using three or more sensitivity parameters.

The provider's expected profit can be calculated in a variety of ways. In one aspect, the expected profit to the provider from a customer with usage u can be represented by Equation (VIII):

$$X ( u ) = {\sum }_{i = 0}^{m} {Z}_{i} ( u ) {Π}_{i} ( u ) \qquad ( VIII )$$

where Zᵢ(u)Πᵢ(u) is the expected profit from option i from a customer with usage limit u. Accordingly, the total expected profit for all usage limits in the selection of potential warranties is represented by Equation (IX):

$$x = E [ X ( u ) ] = {\int }_{u}^{ } X ( u ) g ( u ) d u \qquad ( IX )$$

Of course, x depends on the warranty products in M and any outside alternatives, so one goal of the provider may be to select the warranty options (pᵢ, lᵢ), i=1, . . . , m to maximize the expected profit per customer, assuming that the outside alternative Jₐ(u) is known.

In another aspect of the present invention, a product warranty selection system is provided. Such a system can include a product and a product warranty selection menu including a plurality of warranty choices and a plurality of product usage limits, where each of the plurality of warranty choices is associated with a different product usage limit. Furthermore, the product warranty selection menu can be determined to increase profit according to the methods described above. The method can further include a selection mechanism that is configured such that the selection of a specific product usage limit from the warranty choices of the product warranty selection menu associates a specific warranty matching the specific product usage limit with the product.

Additionally, in one aspect, the system can further comprise a plurality of product warranty prices, where each of the plurality of product usage limits is associated with a different product warranty price. Such usage limits can vary depending on the type of product to which the warranty is associated. In some cases, the warranty choices can also include a pay-as-you-go warranty choice, where a customer pays for all repairs out of pocket. Furthermore, the number of choices for the warranty selection can vary depending on the number of intended usage limits and the dynamics of the profit pricing situation. In one aspect, however, there can be at least two warranty choices. In another aspect, there can be at least three warranty choices. In yet another aspect, there can be at least four warranty choices.

### EXAMPLES

### Example 1

### Simple Example with Discrete Usage Distribution

The following example utilizes three usage limits having the usage distribution P(U=1)=P(U=3)=¼ and P(U=2)=½. The failure rate function is λ(t|u)=αe^{βu} with α=1 and β=0.5. This corresponds to a constant failure rate over time that is exponentially increasing with usage. Three different values of γ are used for the choice model, namely γ={0.01, 0.15, 0.3}. Furthermore, cost components are cᵣ=$100 and C_{R}=$160. Jₐ(u)=Jₒ(u)-20 to make the alternative $20 cheaper than the policy (pₒ, lₒ)=(0, 0). For each value of γ, the provider's expected profits are computed under five different warranty menus. The first menu, referred to as Base, consists only of the pay-as-you-go option (pₒ, lₒ)=(0, 0). The second menu, Base′, contains the pay-as-you-go option (pₒ, lₒ)=(0, 0) and an optimally-priced unlimited-usage warranty product (p*, 3). These two base menus are compared with menus containing two, three and four products, in which the pay-as-you-go product (pₒ, lₒ)=(0, 0) is always included, and the additional warranty products are selected to maximize profit. The values for usage limits / are restricted to be in {1, 2, 3}. The combination of three values of γ and five warranty menus produces fifteen distinct warranty selection scenarios.

This example demonstrates that offering a usage-dependent warranty menu can significantly improve a provider's profits. When only two warranty products are allowed, with one being (0, 0), the other is typically (p*₁, 1) and the improvements range from 13% for consumers that are not price sensitive to 112% for consumers that are price sensitive. When four warranty products are allowed, the overall profit is increased, ranging from 41% to 122% relative to Base′. Table 1 compares Base′ with usage-limited warranty menus containing two, three and four service products for γ=0.15. For this particular value of γ, we see that a two-warranty menu, the profit improvement over the Base′ scenario is 93%. A three-warranty menu provides a profit improvement of 101 % over the Base′ scenario. A four-warranty meny provides a profit improvement of 102% over the Base′ scenario. Thus, the majority of benefit is extracted from offering the first two warranty options.

TABLE 1
Performance of Different Warranty Menus Relative to Base' for γ = 0.15

| Menu | Revenue | Rel Impr' | p₀ | l₀ | p₁ | l₁ | p₂ | l₂ | p₃ | l₃ |
|---|---|---|---|---|---|---|---|---|---|---|
| Base | $8.23 | −86% | $0 | 0 | | | | | | |
| Base' | $59.80 | 0% | $0 | 0 | | | | | $673.87 | 3 |
| 2 | $115.37 | 93% | $0 | 0 | $185.35 | 1 | | | | |
| 3 | $120.34 | 101% | $0 | 0 | $229.53 | 1 | $398.91 | 2 | | |
| 4 | $120.80 | 102% | $0 | 0 | $229.53 | 1 | $398.91 | 2 | $646.44 | 3 |

### Example 2

### Exemplary Printer Data

The following example demonstrates using warranty option pricing to increase profitability for a generic printer. Assume that failure and usage data of a generic printer are analyzed with 20,216 installed bases to obtain the failure process λ(t|u). Since the failure data is much more reliable within the first year, the extended warranty period is assumed to be [0,w]=[0, 1] and the failure data of the first year after installation is used for the extended period to conduct numerical analysis. Also assume that the expected cost to the provider for each failure is cᵣ=$332, and C_{R}=$689 per repair as pay-as-you-go cost. For customer choice sensitivity parameter γ=0.2, the optimal warranty without usage limit is determined to be priced at $110 resulting in a profit of $14.27. If the number of usage-based warranty options in the menu is restricted to be one, the optimal option with usage limit 13,000 monthly page volume (MPV) priced at $110, i.e., (p*₁, l*₁)=($110, 13000), can double the profit of the provider to $28.62. If the menu has two options, the optimal menu is option 1 with usage limit 7,000 MPV priced at $110 and option 2 with usage limit 16,000 MPV priced at $150, i.e., (p*₁,l*₁)=($110, 7000), (p*₂, l*₂)=($150, 16000), resulting in a profit improvement to $36.50. If the menu can allow three options, the optimal menu is option 1 with usage limit 4,000 MPV priced at $100, option 2 with usage limit 10,000 MPV priced at $130 and option 3 with usage limit 18,000 MPV priced at $180, i.e., (p*₁, l*₁)=($100, 4000), (p*₂, l*₂)=($130, 10000), (p*₃, l*₃)=($180, 18000), resulting in an even higher profit $39.62. If the menu has four options, the profit increases to $41.45 by setting the menu: option 1 with usage limit 2000 MPV priced at $100, option 2 with usage limit 5000 MPV priced at $110, option 3 with usage limit 10000 MPV priced at $130 and option 4 with usage limit 18000 MPV priced at $180, i.e., (p*₁, l*₁)=($100, 2000), (p*₂, l*₂)=($110, 5000), (p*₃, l*₃)=($130, 10000), (p*₄, l*₄)=($180, 18000). As illustrated by this example, with more usage-based options in the warranty the provider can obtain higher revenues by further segmenting the market optimally through usage-based warranty options.

For the same eta=0.8, the optimal profits can be compared with and without usage-based warranty for various values of gamma, and it is clear that using one usage-based warranty option provides the provider with significant profit improvement, as is illustrated in Table 2 and 3. It should be noted that eta is the fraction of the provider's repair cost that a competing service provider charges per repair.

TABLE 2
Optimal One-Option Menu as λ Varies From 0.1 to 1

| | γ | | | | | | | | | |
|---|---|---|---|---|---|---|---|---|---|---|
| | 0.1 | 0.2 | 0.3 | 0.4 | 0.5 | 0.6 | 0.7 | 0.8 | 0.9 | 1 |
| opt. usage lim. | 14000 | 13000 | 13000 | 13000 | 13000 | 13000 | 13000 | 13000 | 17000 | 21000 |
| (MPV) | | | | | | | | | | |
| opt. price w/ | 120 | 110 | 110 | 110 | 110 | 110 | 110 | 110 | 110 | 110 |
| usage lim. ($) | | | | | | | | | | |
| opt. profit w/ | 28.05 | 28.64 | 29.38 | 29.70 | 29.85 | 29.91 | 29.95 | 29.97 | 24.85 | 21.16 |
| usage lim. ($) | | | | | | | | | | |
| Provider's market | 68.2 | 85.2 | 87.0 | 87.8 | 88.2 | 88.4 | 88.5 | 88.6 | 89.2 | 89.2 |
| share (%) | | | | | | | | | | |
| opt. price w/o | 120 | 110 | 110 | 110 | 110 | 110 | 110 | 110 | 110 | 110 |
| usage lim. ($) | | | | | | | | | | |
| opt. profit w/o | 15.42 | 14.30 | 14.90 | 15.17 | 15.29 | 15.35 | 15.38 | 15.40 | 15.41 | 15.42 |
| usage lim. ($) | | | | | | | | | | |
| Provider's market | 69.1 | 86.0 | 87.7 | 88.4 | 88.8 | 89.0 | 89.1 | 89.1 | 89.2 | 89.2 |
| share (%) | | | | | | | | | | |
| Improvement of | 82% | 100% | 97% | 96% | 95% | 95% | 95% | 95% | 61% | 37% |
| profit | | | | | | | | | | |

TABLE 3
Optimal One-Option Menu as λ Varies From 0.01 to 0.1

| | γ | | | | | | | | | |
|---|---|---|---|---|---|---|---|---|---|---|
| | 0.01 | 0.02 | 0.03 | 0.04 | 0.05 | 0.06 | 0.07 | 0.08 | 0.09 | 0.1 |
| opt. usage lim. | 14000 | 15000 | 16000 | 16000 | 15000 | 14000 | 14000 | 14000 | 14000 | 14000 |
| (MPV) | | | | | | | | | | |
| opt. price w/ | 240 | 180 | 160 | 150 | 140 | 130 | 130 | 120 | 120 | 120 |
| usage lim. ($) | | | | | | | | | | |
| opt. profit w/ | 59.44 | 45.20 | 38.25 | 34.05 | 31.54 | 30.02 | 28.90 | 28.42 | 28.20 | 28.05 |
| usage lim. ($) | | | | | | | | | | |
| Provider's market | 51.3 | 48.8 | 48.9 | 49.4 | 52.1 | 57.8 | 56.8 | 67.9 | 68.1 | 68.2 |
| share (%) | | | | | | | | | | |
| opt. price w/o | 270 | 200 | 180 | 160 | 150 | 140 | 130 | 130 | 130 | 120 |
| usage lim. ($) | | | | | | | | | | |
| opt. profit w/o | 55.74 | 39.63 | 31.20 | 25.81 | 21.14 | 19.67 | 17.89 | 16.85 | 15.97 | 15.42 |
| usage lim. ($) | | | | | | | | | | |
| Provider's market | 50.8 | 47.9 | 44.8 | 46.5 | 47.7 | 51.8 | 59.0 | 58.0 | 57.0 | 69.1 |
| share (%) | | | | | | | | | | |
| Improvement of | 7% | 14% | 23% | 32% | 49% | 53% | 62% | 69% | 77% | 82% |
| profit | | | | | | | | | | |

While the invention has been described with reference to certain preferred embodiments, those skilled in the art will appreciate that various modifications, changes, omissions, and substitutions can be made without departing from the spirit of the disclosure. It is therefore intended that the invention be limited only by the scope of the appended claims.

What is claimed is:

1. A method of pricing limited use product warranties to increase profit, comprising:
a) obtaining a failure rate for a product by accessing failure and usage data over a computer network from a database on a server;
b) selecting a first plurality of potential warranty options, wherein each warranty option has an associated product usage limit and an associated warranty purchase cost;
c) utilizing a computer system to calculate a customer's expected support cost based on the failure rate for the product for each of the first plurality of warranty options;
d) determining an expected customer demand for each of the first plurality of warranty options;
e) utilizing the computer system to calculate a provider's expected option profit for each of the first plurality of warranty options; and
f) utilizing the computer system to calculate a provider's expected total profit for the first plurality of warranty options.

2. The method of claim 1, further comprising:
selecting a second plurality of potential warranty options, wherein each warranty option has an associated product usage limit and an associated warranty purchase cost;
repeating steps c) through e) and calculating a provider's expected total profit for the second plurality of warranty options; and
retaining either the first plurality of warranty options or the second plurality of warranty options.

3. The method of claim 2, wherein retaining the first plurality of warranty options or the second plurality of warranty options includes:
determining a highest provider's expected profit by comparing the provider's expected total profit for the first plurality of warranty options with the provider's expected total profit for the second plurality of warranty options; and
retaining the warranty options associated with the highest provider's expected total profit.

4. The method of claim 1, wherein the customer's expected support cost includes the warranty purchase cost and an expected repair cost for failures that are not warranty-covered.

5. The method of claim 1, wherein determining the customer expected demand for each of the first plurality of warranty options further includes utilizing the computer system to calculate a customer choice probability for each of the first plurality of warranty options.

6. The method of claim 5, further comprising utilizing a customer cost sensitivity parameter to calculate the customer choice probability.

7. The method of claim 5, further comprising utilizing a plurality of customer cost sensitivity parameters to calculate the customer choice probability, wherein each of the plurality of customer cost sensitivity parameters is different.

8. The method of claim 1, wherein the provider's expected option profit is based on the customer's expected cost and the customer expected demand.

9. The method of claim 1, wherein calculating a provider's expected total profit includes summing the provider's expected option profits for the first plurality of warranty options.

10. The method of claim 1, wherein the computer system is operatively coupled to the computer network.

11. A product warranty selection system, comprising:
a) a product;
b) a product warranty selection menu including a plurality of warranty choices and a plurality of product usage limits, wherein each of the plurality of warranty choices is associated with a different product usage limit, and wherein the product warranty selection menu has been optimized to increase profit by:
i) obtaining a failure rate for a product by accessing failure and usage data,
ii) selecting a first plurality of potential warranty options, wherein each warranty option has an associated product usage limit and an associated warranty purchase cost,
iii) calculating a customer's expected support cost based on the failure rate for the product for each of the first plurality of warranty options,
iv) determining an expected customer demand for each of the first plurality of warranty options,
v) calculating a provider's expected option profit for each of the first plurality of warranty options, and
vi) calculating a provider's expected total profit for the first plurality of warranty options; and
c) a selection mechanism configured such that selection of a specific product usage limit from the warranty choices of the product warranty selection menu associates a specific warranty with the specific product usage limit of the product.

12. The system of claim 11, further comprising a plurality of product warranty prices, wherein each of the plurality of product usage limits is associated with a different product warranty price.

13. The system of claim 11, wherein one of the plurality of warranty choices includes a pay-as-you-go warranty choice.

14. The system of claim 11, wherein the plurality of warranty choices is at least three warranty choices having different product usage limits.

15. The system of claim 11, wherein the plurality of warranty choices is at least four warranty choices having different product usage limits.

16. The system of claim 11, wherein each of the plurality of product usage limits represents a total accumulated usage of the product during a warranty period.

17. The system of claim 11, wherein the plurality of product usage limits represents a product usage rate.
